(19) United States
(12) Patent Application Publication
(10) Pub. No.: US 2010/0098815 A1
(43) Pub. Date: Apr. 22, 2010

(54) CANNED DOUGH PRODUCT HAVING INGREDIENT POUCH

(76) Inventors: Penny L. Norquist, St. Paul, MN (US); Cam Tran, Plymouth, MN (US); Claire Thurbush, Minneapolis, MN (US)

Correspondence Address: GENERAL MILLS, INC., P.O. BOX 1113, MINNEAPOLIS, MN, 55440, US

(21) Appl. No.: 12/375,424

(22) PCT Filed: Aug. 2, 2007
(86) PCT No.: PCT/US07/75025

§ 371 Date: Oct. 22, 2009

Related U.S. Application Data
(60) Provisional application No. 60/835,523, filed on Aug. 4, 2006.

(51) Int. Cl. A21D 10/02; B65D 81/32

(52) U.S. Cl. 426/120; 426/392

(57) ABSTRACT

A canned dough product includes an ingredient pouch in physical contact with the dough such that a conventional can format including a cylindrical body and end caps can be used to package and store the canned dough product. The ingredient pouch can be configured for placement proximate an end cap or between adjacent dough units or alternatively, for placement between adjacent layers of a rolled dough unit. The ingredient pouch is constructed to survive long-term exposure to positive pressures up to about 60 psig without imparting negative characteristics to the dough.

### FIELD OF THE INVENTION

The invention relates to canned dough packaging for dough products and, more particularly, to canned dough packaging having an ingredient pouch in contact with the dough products.

### BACKGROUND OF THE INVENTION

Due to the time demands placed on consumers by the every day activities of modern life, the preparation of food products and meals from scratch has decreased and the popularity of pre-made or partially pre-made foods has increased dramatically. A food product that has become increasingly popular in a pre-made configuration are dough based food products such as, for example, developed and undeveloped dough products. These dough products can be stored in either a refrigerated or frozen state for extended periods and are “freshly” prepared in a matter of minutes as desired by the consumer. In some instances, these dough products can represent a substantially final product requiring only a heating or baking step such as, for example, cookies, bread, bread sticks, biscuits and croissants. Alternatively, these dough precuts can represent components or building blocks of a final product such as, for example, a pie crust or pizza dough that will be combined with a variety of other ingredients to form in the final product. Regardless of whether the dough product itself constitutes a final product or merely a component of the final product, these dough products constitute enormous time savers for the consumer in that the consumer need not prepare the dough products from scratch using base ingredients such as, for example, flour, water, eggs, yeast, salt, sugar and the like.

One popular method for packaging and storing dough products has been to use a can format, wherein the dough product is contained within a cylindrical body having caps at both ends of the body. Depending upon the dough product, these cans can be constructed to withstand increased internal pressures.

While the can format can work very well for dough products, there are some instances in which it is desirable to include additional ingredients with the dough product in order to complete or enhance enjoyment of the final cooked dough product. In order to accommodate these additional ingredients in a can format, a variety of designs have been utilized to create separate storage areas or compartments for separating the additional ingredients from the dough. Representative can designs for accommodating both dough and additional ingredients can include those disclosed in U.S. Pat. Nos. 5,447,236 and 5,749,460, which describe the use of cup assemblies and/or metal separators to separate the additional ingredients from the dough. While cup assemblies can be successfully used to separate and store both dough and additional ingredients in a can format, the use of these cup assemblies can lead to an increase in packaging costs due to increased raw material costs and packaging complexities.

As such, it would be advantageous to have a canned dough package wherein dough and additional ingredients can be simultaneously packaged while avoiding the disadvantages associated with the prior art.

### BRIEF SUMMARY OF THE INVENTION

The embodiments of the invention described below are not intended to be exhaustive or to limit the invention to the precise forms disclosed in the following detailed description. Rather, the embodiments are chosen and described so that others skilled in the art may appreciate and understand the principles and features of the invention.

In a representative embodiment, a canned dough assembly can comprise an ingredient pouch in physical contact with a dough product such that a conventional can format including a cylindrical body and end caps can be used to package and store the canned dough product and ingredient pouch. In some embodiments, the ingredient pouch can comprise a generally round-shaped pouch adapted for placement proximate an end cap or between the dough product configured in the form of individual, adjacent dough units. In some embodiments, the ingredient pouch can comprise an elongated and/or rectangular shaped pouch adapted for placement between adjacent layers of the dough product configured in a rolled dough unit.

In another representative embodiment, a method for packaging a canned dough product can comprise positioning an ingredient pouch so as to be in intimate contact with a dough product when packaged within a can format. In some embodiments, the ingredient pouch can be placed on a surface of a flat dough sheet that is subsequently rolled-up for packaging such that the ingredient pouch is located between adjacent rolled layers of a dough product. In some embodiments, the ingredient pouch can be positioned between an end cap and the dough product. In some embodiments, the ingredient pouch can be positioned between individual dough units within the can package.

The above summary of the various representative embodiments of the invention is not intended to describe each illustrated embodiment or every implementation of the invention. The figures in the detailed description that follow more particularly exemplify these embodiments.

### BRIEF DESCRIPTION OF THE DRAWINGS

These, as well as other objects and advantages of this disclosure, will be more completely understood and appreciated by referring to the following more detailed description of the presently preferred exemplary embodiments of the invention in conjunction with the accompanying drawings, of which:

FIG. 1 is a side view of an embodiment of a dough container.

FIG. 2 is a side, section view of a multi-layer material used to form a cylindrical body of the dough container of FIG. 1.

FIG. 3 is a section view of the dough container 100 taken at line 3-3 of FIG. 1 including a dough product 116.

FIG. 4 is a perspective view of an embodiment of a flat dough sheet having individually defined dough units.

FIG. 5 is a top view of an embodiment of a rectangular flavor pouch.

FIG. 6 is a top view of an embodiment of a square flavor pouch.

FIG. 7 is a top view of an embodiment of a round flavor pouch.

FIG. 8 is a side, partial cut-away view of an embodiment of a canned dough product having the rectangular flavor pouch of FIG. 5 positioned directly between a rolled dough sheet and a can.

FIG. 9 is a side, partial cut-away view of an embodiment of a canned dough product having the round flavor pouch of FIG. 7 positioned directly between a rolled dough unit and an end cap.

FIG. 10 is a side, partial cut-away view of an embodiment of a canned dough product having the square flavor pouch of FIG. 6 positioned directly between adjacent layers of a rolled dough sheet.

### DETAILED DESCRIPTION OF THE PREFERRED EMBODIMENTS

As used herein the term “dough” refers to an article that is produced or manufactured which is in a non-baked condition and requires some further thermal processing such as baking, cooking or frying to change the properties of the dough such that is suitable for consumption. As used throughout the specification, “dough” can refer to any of a variety of dough types such as, for example, developed dough and undeveloped dough was well as a variety of dough products such as, for example, biscuits, rolls, bread, bread sticks, cookies, croissants, pizza crust and pie crust.

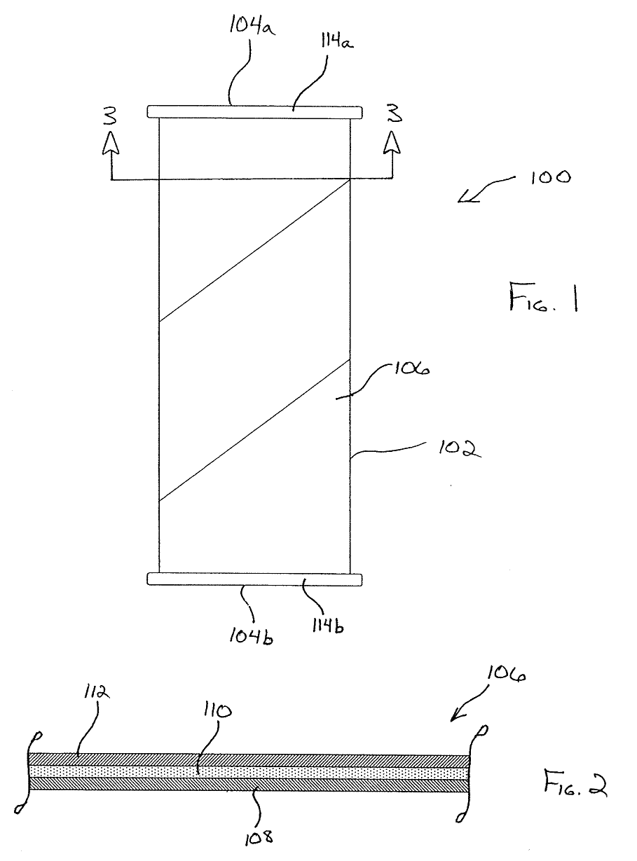

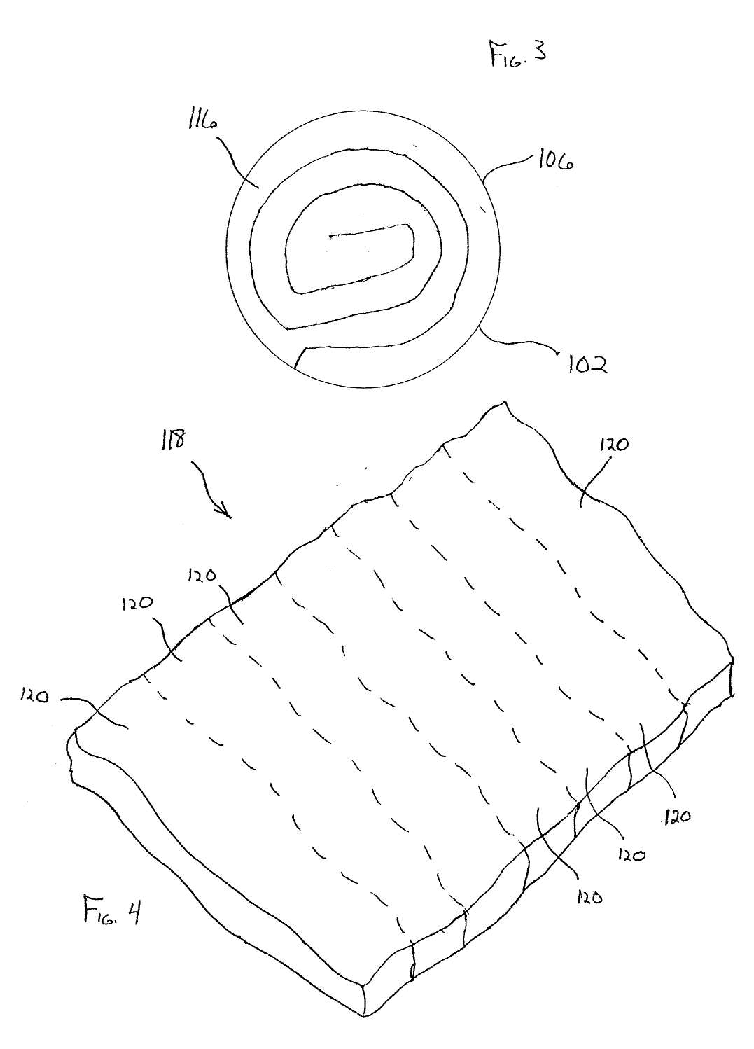

As illustrated in FIG. 1, a dough container 100 can comprise a cylindrical body 102 having a first end 104a and a second end 104b. With respect to the use of the terms “first” and “second” in regard to dough container 100, such terms are used to merely distinguish the opposed ends and do not signify any order relative to construction or opening of dough container 100. Cylindrical body 102 can comprise a multi-layer composite material 106 having an inner layer 108, a core layer 110 and an exterior layer 112 as depicted in FIG. 2. Multi-layer composition material 106 can be wrapped around a mandrel to form the cylindrical body 102, wherein the size of the mandrel determines the diameter of the cylindrical body 102. In use, cylindrical body 102 is enclosed with a first end cap 114a and a second end cap 114b. First end cap 114a and second end cap 114b can comprise suitable materials of construction including metals such as, for example, aluminum and steel, plastics such as, for example, polyethylene as well as paper based materials. Additional details relating to the fabrication of a container such as dough container 100 can be found in U.S. Pat. Nos. 3,510,050; 4,073,950; 4,093,073; 4,919,949; 5,314,702; 5,326,023; and 5,749,460, all of which are assigned to the Pillsbury Company and General Mills, Inc., of Minneapolis, Minn.

Generally, dough container 100 is used to package a dough product 116 such as, for example, biscuits, pizza crust and rolls. Dough product 116 can comprise developed, underdeveloped, or undeveloped dough products as well as chemically leavened or yeast leavened dough products. When preparing dough product 116, a first step can include forming a flat dough sheet 118 using high-volume processing and mixing equipment. Depending upon the configuration of dough product 116, flat dough sheet 118 can be cut and/or perforated to define individual dough units 120 such as, for example, biscuits and croissants, within the flat dough sheet 118. In some embodiments, the individual dough units 120 will be rolled or otherwise cut so as to fit within dough container 100.

Dough formulations, and the ingredients they contain, can differ depending on the finished product that is obtained from the dough. However, most dough generally have a number of ingredients in common and examples of some such common ingredients are described and illustrated in more detail below.

Dough as described and referenced herein generally contains a grain constituent that contributes to the structure of the dough. Different grain constituents lend different texture, taste and appearance to a baked good. Flour is the most commonly used grain constituent in baked goods, and in most baked foods is the primary ingredient. Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

Bread flours are primarily milled from hard red winter or spring wheat. Generally these flours have a protein content of about 11.0-12.5%. Certain baked products may require stronger bread flours with about 1-2% higher protein content.

In bread making, flour may comprise up to about 95 weight percent of the dry ingredients. In bread, when the flour comes in contact with water, and the ingredients are mixed, the gluten protein fraction forms elastic, gas-retaining films.

Dough compositions can be caused to expand (leaven) by any leavening mechanism, such as by one or more of the effects of: entrapped gas such as entrapped carbon dioxide, entrapped oxygen, or both; a laminated dough structure; by action of chemical leavening agents; or by action of a biological agent such as a yeast. Thus, a leavening agent may be an entrapped gas such as layers or cells (bubbles) that contain carbon dioxide, water vapor, or oxygen, etc.; any type of yeast (e.g., cake yeast, cream yeast, dry yeast, etc.); or a chemical leavening system, e.g., containing a basic chemical leavening agent and an acidic chemical leavening agent that react to form a leavening gas such as carbon dioxide.

Examples of acidic chemical leavening agents are generally known in the dough and bread-making arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), glucono-delta-lactone (GDL), as well as a variety of others. Optionally, an acidic chemical leavening agent for use in accordance with the present disclosure can be encapsulated.

Examples of basic chemical leavening agents include many that are generally known in the dough and baking arts, such as soda, i.e., sodium bicarbonate (NaHCO₃), potassium bicarbonate (KHCO₃), ammonium bicarbonate (NH₄HCO₃), etc. A basic chemical leavening agent may also be encapsulated, if desired.

The evolution of carbon dioxide essentially follows the stoichiometry of typical acid-base reactions. The amount of leavening base present determines the amount of carbon dioxide evolved, whereas the type of leavening acid affects the speed at which the carbon dioxide is liberated. The amount of leavening base used in combination with the leavening acid can be balanced such that a minimum of unchanged reactants remain in the finished product. An excess amount of leavening base can impart a bitter flavor to the final product, while excess leavening acid can make the baked product tart.

Yeast is also utilized for leavening baked goods, and is often preferred because of the desirable flavor it imparts to the dough. Baker's yeast is generally supplied in three forms: yeast cream, a thick suspension with about 17% solids; a moist press cake with about 30% solids; and an active dry yeast, with about 93 to 98% solids. Generally, active dry yeasts of acceptable quality have been available for some time, and recently instant active dry yeast has also been available for commercial use.

The quantity of yeast added to dough is directly related to the time required for fermentation, and the form of the yeast utilized. Generally, most bread doughs are made with from about 2 to 3% fresh compressed yeast, based on the amount of flour.

Suitable dough as used herein can also constitute additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Either natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Dough-developing agents can also be added to the system to increase dough viscosity, texture and plasticity. Any number of agents known to those of skill in the art may be used including azodicarbonamide, diacetyl tartaric acid ester of mono- and diglycerides (D.A.T.E.M.) and potassium sorbate.

Another example of a dough-developing additive is PROTASE™. PROTASE™ is a proprietary product containing enzymes and other dough conditioners. PROTASE™ is generally used to reduce mixing time and improve machinability. A double strength version, PROTASE 2X™, is commercially obtained from J. R. Short Milling Co. (Chicago, Ill.).

Dough conditioners are also examples of dough additives. One example of a dough conditioner is NUBAKE™, commercially available from RIBUS (St. Louis, Mo.). Another example of a dough conditioner is L-cysteine, commercially available from B.F. Goodrich (Cincinnati, Ohio).

Dough can also frequently contain nutritional supplements such as vitamins, minerals and proteins, for example. Examples of specific nutritional supplements include thiamin, riboflavin, niacin, iron, calcium, or mixtures thereof.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

Representative methods for mixing dough can include but not be limited to a straight dough method, and a sponge and dough method. Mixing details can therefore depend in part on the type of dough that is being mixed, and the method of mixing that is generally used with that type of dough. For example, some chemically leavened Boughs require a two step process. Methods can also incorporate varied mixing times. The time a dough is mixed using the presently contemplated methods can depend in part on the type of dough that is being mixed and the general process that is being used.

Generally, the step of combining the ingredients in the mixing system depends on the particular ingredients, the type of dough being mixed, the type of process being used, and the type of mixing system being used. One of skill in the art, having read this specification, could apply any of the many known processes and mixing systems, based on the ingredients used to accomplish this step (ingredient combination).

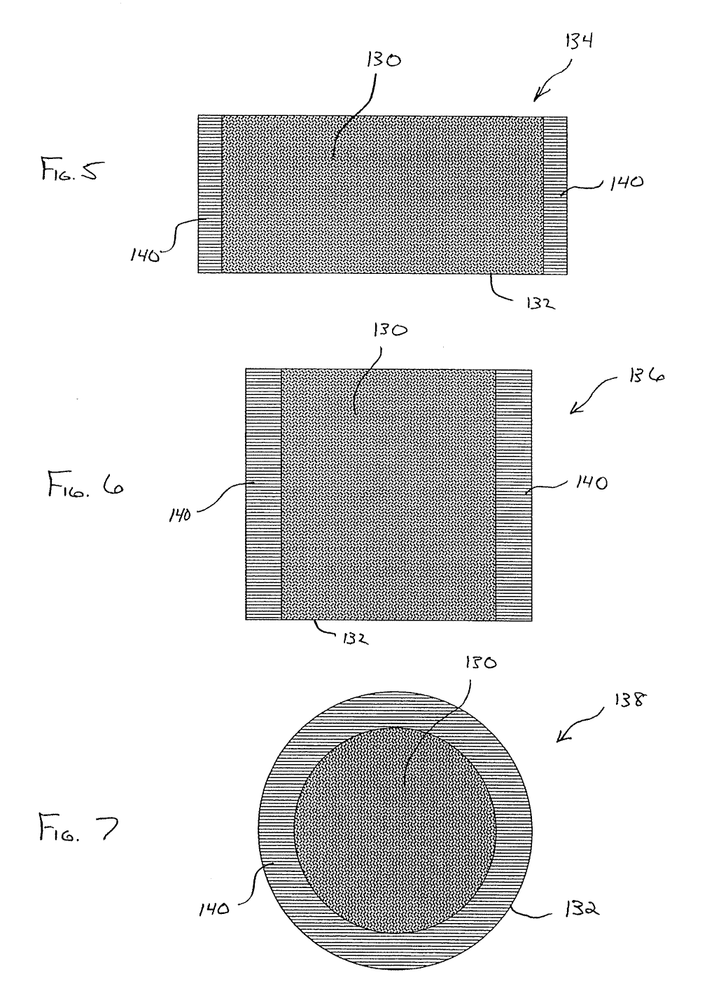

As illustrated in FIGS. 5, 6 and 7, a flavorant 130 can be packaged within a barrier material 132 to form a flavor pouch such as, for example, a rectangular flavor pouch 134, a square flavor pouch 136, a round flavor pouch 138 or other suitable pouch shapes. Flavorant 130 can comprise any suitable flavorant type including crystallized flavorants such as, for example, sugar or salt, powder type flavorants such as, for example, flour or spices or flowable flavorants such as, for example, icing and butter. Generally, each flavor pouch comprises one or more portions of barrier material 132 enclosed at a seal 140. Seal 140 can be formed using a suitable method such as, for example, heat and/or adhesive sealing of adjacent portions of barrier material 132. When sealed, the flavor pouch is capable of retaining its retention capabilities up to at least 35 psig. Each flavor pouch preferably has a flavorant capacity between about 2 grams to about 35 grams of flavorant.

Barrier material 132 generally comprises a high barrier material selected for its ability to prevent oxygen migration through the barrier material. In one preferred embodiment, barrier material 132 comprises a polymeric film containing a EVOH barrier film. A representative barrier material 132 can include, for example, high density polyethylene (HDPE). Alternatively, other materials can be used for barrier material 132 as long as the materials are suitable for food contact and have reduced oxygen permeability. In some embodiments, barrier material 132 can have an oxygen permeability of less than about 0.3 cc of O₂ per 100 in² of material at 73° F. (22.8° C.) and 0% relative humidity. Another representative barrier material 132 can comprise a metallized polyethylene terephthalate (PET) structure having an oxygen permeability of less than about 0.1 cc of O₂ per 100 in² of material at 73° F. (22.8° C.) and 0% relative humidity.

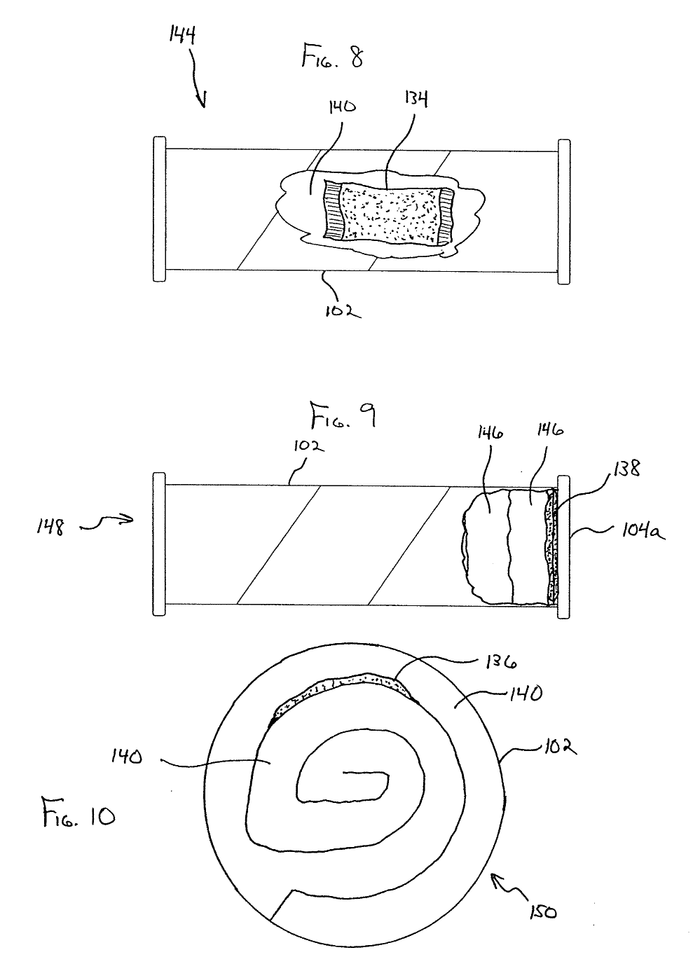

In contrast to prior art canned dough products in which flavorants are packaged within cups or separated from dough by separators, the previously described flavor pouches are configured to be placed into direct contact with dough inside the dough container 100. As illustrated in FIG. 8, rectangular flavor pouch 134 pouch can be positioned directly between a rolled dough sheet 140 and the inner layer 108 of cylindrical body 102 to form a canned dough product 144. Alternatively, round flavor pouch 138 can be positioned at either of first end 104a or second end 104b such that the round flavor pouch 138 is directly between a rolled dough intermediate 146 and either first end cap 114a or second end cap 114b to form a canned dough product 148 as illustrated in FIG. 9. In yet another embodiment, square flavor pouch 136 can be rolled within flat dough sheet 118 as it rolled for placement within dough container 100 such that the square flavor pouch 136 is surrounded by adjacent layers of rolled dough sheet 140 to form a canned dough product 150. As will be understood by one of skill in the art, the different flavor pouch shapes can be used in the differing locations within the dough container 100 as presently disclosed and are not intended to be limited strictly to the configurations illustrated in FIGS. 8, 9 and 10. In addition, an embodiment of a canned dough product can comprise two or more flavor pouches, either of the same or different shaped configurations within a single dough container 100.

### EXAMPLES

In order to confirm the feasibility of placing flavor pouches in direct contact with dough products within a can, a battery of testing was performed. This testing including simulated pressure testing and shelf life testing for representative canned dough products including canned bread dough and canned biscuit dough. A number of variables were introduced in the testing including can diameter, pouch placement, pouch shape and pouch volume. With respect to can diameter, data was collect for two sizes representing ranges spanning a minimum can diameter (1.75 inches) and a maximum can diameter (2.875 inches) for presently available canned products. For pouch placement, a variety of pouch locations were tested including positioned at the top of the can, bottom of the can and rolled within the dough product. The pouch was a generally flat pouch having exterior perimeter seams so as to form either a square or rectangular shape. In varying the pouch volume, each pouch was filled with an amount of flavorant ranging from a minimum of 2 grams to a maximum of 35 grams.

### Example 1

### Canned Bread Dough

In a first test, pressures within a dough can were measured to determine if the presence of a flavor pouch in direct contact with Pillsbury® Crusty French Loaf (CFL) bread dough provided unfavorable internal pressures. A batch of CFL dough was prepared and packaged within dough cans having a 1.75 inch diameter to form a CFL canned dough product. Generally, the CFL canned dough product is considered to be within specifications when an internal can pressure is from about 10 psig to about 35 psig over a 90 refrigerated shelf life. Within each dough can, a flavor pouch filled with a crystallized flavorant was positioned in direct contact with the CFL dough, either between the CFL dough and the can or rolled within the CFL dough. Each CFL canned dough product was allowed to sit for 24 hours at 70° F. (21.1° C.) to promote proofing of the CFL dough within the can and to simulate refrigerated proofing over a typical shelf-life of 90 days. Results of the CFL canned dough product pressure simulation are summarized in Table 1 below:

TABLE 1
Results of 24 hour simulated can pressure testing with CFL dough.

| | | Pouch Size | | | Can Pressure |
|---|---|---|---|---|---|
| | Flavorant | (grams of | Pouch | Pouch | @ 24 hours |
| Can # | Type | flavorant) | Placement | Shape | (psi) |
| 1 | sea salt | 2 | top | square | 16.87 |
| 2 | sea salt | 2 | bottom | square | 15.16 |
| 3 | sea salt | 5 | top | square | 15.96 |
| 4 | sea salt | 5 | top | rectangular | 16.96 |
| 5 | sea salt | 5 | bottom | rectangular | 16.89 |
| 6 | sea salt | 15 | top | rectangular | 17.44 |
| 7 | sea salt | 15 | bottom | rectangular | 16.04 |
| 8 | crystal | 2.5 | in roll | rectangular | 17.23 |
| | light ® | | | | |
| 9 | sea salt | 20 | in roll | rectangular | 17.78 |
| 10 | sea salt | 35 | in roll | rectangular | 17.49 |

As illustrated in Table 1, the presence of the flavor pouch in direct contact with the CFL dough did not have a negative effect on the can pressure. Regardless of flavorant type, pouch size, pouch placement or pouch shape, the internal can pressures were within the generally accepted range for a satisfactory CFL canned dough product.

After confirming that the use of flavor pouches in a CFL canned dough product can achieve satisfactory pressure results in simulated testing, additional testing was performed to confirm the results following extended periods of refrigerated storage. In addition to evaluating can pressure, other performance variables were observed including dough appearance, oil pooling, dough tearing and flavor pouch appearance. With respect to dough appearance, a visible examination of the CFL dough was especially directed to identifying the presence of “grey dough”, which, if grey dough is present provides an indication that oxygen from the flavor pouch has migrated from the flavor pouch into the CFL dough, or alternatively, that the flavor pouch has blocked venting channels located at the can end. One mechanism by which oxygen can migrate from the flavor pouch is that as the CFL dough proofs during refrigerated storage, the levels of CO₂ within the CFL canned dough product increase such that the CO₂ and oxygen equilibrate within the CFL canned dough product.

In a first extending shelf-life test, flavor pouches were constructed using HDPE (high density polyethylene). Within each pouch, varying amounts of sea salt were enclosed and sealed. A batch of CFL dough was prepared and the CFL dough and flavor pouches were packaged within dough cans having a 1.75 inch diameter to form a CFL canned dough product. The CFL canned dough products were then placed into refrigerated storage. The CFL canned dough products were opened and inspected following two weeks of refrigerated storage. Results of the two week testing CFL canned dough product including flavorant pouch formed from HDPE are summarized in Table 2 below:

TABLE 2
Pouch material testing after two weeks with canned CFL dough.

| | Pouch Size | | | |
|---|---|---|---|---|
| | (grams of | Pouch | | Grey Dough |
| Can # | flavorant) | Placement | Pouch Shape | Present |
| 1 | 2 | bottom | square | no |
| 2 | 5 | bottom | square | yes |
| 3 | 5 | top | square | yes |
| 4 | 2 | top | square | yes |
| 5 | 11 | side | square | yes |
| 6 | 5 | side | rectangular | yes (slight) |
| 7 | 5 | side | rectangular | yes (slight) |

As illustrated in Table 2, six of the seven cans had some amount of grey dough present when opened after two weeks of refrigerated storage. This provided evidence that the selection of pouch material is critical to the prevention of grey dough when the flavor pouch is packaged in direct contact with dough. In order to successfully position a flavor pouch in direct contact with the dough, the use of a high barrier film in forming the flavor pouch is necessary to prevent the migration of oxygen from inside the flavor pouch to the dough as well as from the dough to the pouch ingredients.

In the next round of shelf-life testing, flavor pouches were constructed using a high barrier film. Within each pouch, varying amounts of sea salt or crystal light were enclosed and sealed. Pouches were constructed in either square or rectangular configurations. A batch of CFL dough was prepared and the CFL dough and flavor pouches were packaged within dough cans having a 1.75 inch diameter to form a CFL canned dough product. The CFL canned dough products were then placed into refrigerated storage. After twenty days, each CFL canned dough product was opened and the CFL dough was inspected for the presence of grey dough. Results of the twenty day shelf-life test for the CFL canned dough product including a flavor pouch with a high barrier material are summarized in Table 3 below:

TABLE 3
20 day shelf-life test with CFL canned dough product having high
barrier pouch material.

| | | Pouch | | | |
|---|---|---|---|---|---|
| | | Size | | | |
| | Flavorant | (grams of | Pouch | Pouch | Grey Dough |
| Can # | Type | flavorant) | Placement | Shape | Present |
| 1 | sea salt | 2 | top | square | No |
| 2 | sea salt | 2 | bottom | square | No |
| 3 | sea salt | 5 | top | square | No |
| 4 | sea salt | 5 | top | rectangle | No |
| 5 | sea salt | 5 | bottom | rectangle | No |
| 6 | sea salt | 15 | top | rectangle | No |
| 7 | sea salt | 15 | bottom | rectangle | No |
| 8 | crystal | 2.5 | in roll | rectangle | No |
| | light | | | | |
| 9 | sea salt | 20 | in roll | rectangle | No |
| 10 | sea salt | 35 | in roll | rectangle | No |

As illustrated in Table 3, use of a high barrier film in constructing the flavor pouch successfully eliminated the presence of grey dough in the CFL canned dough product after twenty day of refrigerated storage regardless of flavorant type, flavorant amount, pouch shape or pouch placement within the can.

Concurrently with the 20-day shelf life testing discussed with respect to Table 3 above, additional CFL canned dough products having flavor pouches constructed of a high barrier material were placed into refrigerated storage for 41 days and 100 days respectively. The results of the 41 day testing are contained in Table 4 below with the 100 day results being summarized in Table 5 below. With respect to the results summarized in Tables 3, 4 and 5, the CFL canned dough products including dough formulation and flavor pouch construction were the same for each test with the only variable being refrigerated storage length.

TABLE 4
41 day shelf-life test with CFL canned dough product having high
barrier pouch material.

| | | Pouch | | | |
|---|---|---|---|---|---|
| | | Size | | | |
| | Flavorant | (grams of | Pouch | Pouch | Grey Dough |
| Can # | Type | flavorant) | Placement | Shape | Present |
| 1 | sea salt | 2 | top | square | No |
| 2 | sea salt | 2 | bottom | square | No |
| 3 | sea salt | 5 | top | square | No |
| 4 | sea salt | 5 | top | rectangle | *Yes. |
| 5 | sea salt | 5 | bottom | rectangle | No |
| 6 | sea salt | 15 | top | rectangle | No |
| 7 | sea salt | 15 | bottom | rectangle | No |
| 8 | crystal | 2.5 | in roll | rectangle | No |
| | light | | | | |
| 9 | sea salt | 20 | in roll | rectangle | No |
| 10 | sea salt | 35 | in roll | rectangle | No |

*2 of 3 samples included grey dough adjacent the flavor pouch. It is believed that this is a result of errors during the formation of the flavor pouch and packaging of the CFL canned dough product.

TABLE 5
100 day shelf-life test with CFL canned dough product having high
barrier pouch material.

| | | Pouch | | | |
|---|---|---|---|---|---|
| | | Size | | | |
| | Flavorant | (grams of | Pouch | Pouch | Grey Dough |
| Can # | Type | flavorant) | Placement | Shape | Present |
| 1 | sea salt | 2 | top | square | No |
| 2 | sea salt | 2 | bottom | square | No |
| 3 | sea salt | 5 | top | square | No |
| 4 | sea salt | 5 | top | rectangle | No |
| 5 | sea salt | 5 | bottom | rectangle | No |
| 6 | sea salt | 15 | top | rectangle | No |
| 7 | sea salt | 15 | bottom | rectangle | No |
| 8 | crystal | 2.5 | in roll | rectangle | No |
| | light | | | | |
| 9 | sea salt | 20 | in roll | rectangle | No |
| 10 | sea salt | 35 | in roll | rectangle | No |

With the exception of Can 4 in the 41 day testing as contained in Table 4, which is believed to be an erroneous result, the use of a high barrier film in constructing the flavor pouch successfully eliminated the presence of grey dough in the CFL canned dough product after 41 and 100 days of refrigerated storage regardless of flavorant type, flavorant amount, pouch shape or pouch placement within the can.

### Example 2

### Canned Biscuit Dough

At the same time that the CFL canned dough products were tested, similar testing was undertaken using Pillsbury® Grands® Buttermilk Biscuit (GBB) dough. As discussed previously with respect to the CFL dough, pressures within a GBB canned dough product were simulated and measured to determine if the presence of a flavor pouch in direct contact with GBB dough would provide acceptable internal pressures. Aside from testing a different dough, one significant difference with the GBB canned dough product is the use of a larger, 2.875 inch diameter can in forming the GBB canned dough product. Generally, the GBB canned dough product is considered to be within specifications when an internal can pressure is from about 10 psig to about 25 psig over a 90 day refrigerated shelf life. Within each dough can, a flavor pouch filled with a crystallized flavorant was positioned in direct contact with the GBB dough, either between the GBB dough and the can or rolled within the GBB dough. Each GBB canned dough product was allowed to sit for 24 hours at 70° F. to promote proofing of the GBB dough within the can and to simulate refrigerated proofing over a typical shelf-life of 90 days. Results of the GBB canned dough product pressure simulation are summarized in Table 6 below:

TABLE 6
Results of 24 hour simulated can pressure testing with GBB dough.

| | | Pouch Size | | | Can Pressure |
|---|---|---|---|---|---|
| | Flavorant | (grams of | Pouch | Pouch | @ 24 hours |
| Can # | Type | flavorant) | Placement | Shape | (psi) |
| 1 | sea salt | 2 | top | square | 18.42 |
| 2 | sea salt | 2 | bottom | square | 18.64 |
| 3 | sea salt | 5 | top | square | 18.76 |
| 4 | sea salt | 5 | top | rectangular | 18.84 |
| 5 | sea salt | 5 | bottom | rectangular | 18.69 |
| 6 | sea salt | 15 | top | rectangular | 19.28 |
| 7 | sea salt | 15 | bottom | rectangular | 19.22 |
| 8 | crystal | 2.5 | in roll | rectangular | 18.70 |
| | light ® | | | | |
| 9 | sea salt | 10 | in roll | rectangular | 19.14 |
| 10 | sea salt | 25 | in roll | rectangular | 20.03 |

As illustrated in Table 6, the presence of the flavor pouch in direct contact with the GBB dough did not have a negative effect on the can pressure. Regardless of flavorant type, pouch size, pouch placement or pouch shape, the internal can pressures were within the generally accepted range for a satisfactory GBB canned dough product.

Following confirmation that the use of flavor pouches in a GBB canned dough product can achieve satisfactory pressure results in simulated testing, additional shelf-life testing was performed to confirm the results following extended periods of refrigerated storage. GBB canned dough products were prepared, placed into refrigerated storage and evaluated at intervals of 20 days, 41 days and 100 days with the results being summarized in Tables 7, 8 and 9 below. Flavor pouches were constructed using the same, high barrier film used with the CFL canned dough testing previously discussed with respect to Tables 3, 4 and 5.

In preparing the GBB canned dough products, varying amounts of sea salt or crystal light were enclosed and sealed within the flavor pouches. Pouches were constructed in either square or rectangular configurations. A common batch of GBB dough was prepared and the GBB dough and flavor pouches were packaged within dough cans having a 2.875 inch diameter to form a GBB canned dough product. The GBB canned dough products were then placed into refrigerated storage. Results of the 20 day shelf-life testing are summarized in Table 7. Results for the 41 day shelf-life testing are contained in Table 8. Results for the 100 day shelf-life testing are summarized in Table 9.

TABLE 7
20 day shelf-life test with GBB canned dough product having high
barrier pouch material

| | | Pouch Size | | | Grey |
|---|---|---|---|---|---|
| | Flavorant | (grams of | Pouch | Pouch | Dough |
| Can # | Type | flavorant) | Placement | Shape | Present |
| 1 | sea salt | 2 | top | square | No |
| 2 | sea salt | 2 | bottom | square | No |
| 3 | sea salt | 5 | top | square | No |
| 4 | sea salt | 5 | top | rectangle | No |
| 5 | sea salt | 5 | bottom | rectangle | No |
| 6 | sea salt | 15 | top | rectangle | No |
| 7 | sea salt | 15 | bottom | rectangle | No |
| 8 | crystal light | 2.5 | in roll | rectangle | No |
| 9 | sea salt | 10 | in roll | rectangle | No |
| 10 | sea salt | 25 | in roll | rectangle | No |

As illustrated in Table 7, use of a high barrier film in constructing the flavor pouch successfully eliminated the presence of grey dough in the CFL canned dough product after twenty days of refrigerated storage regardless of flavorant type, flavorant amount, pouch shape or pouch placement within the can.

TABLE 8
41 day shelf-life test with GBB canned dough product having high
barrier pouch material

| | | Pouch Size | | | Grey |
|---|---|---|---|---|---|
| | Flavorant | (grams of | Pouch | Pouch | Dough |
| Can # | Type | flavorant) | Placement | Shape | Present |
| 1 | sea salt | 2 | Top | square | No |
| 2 | sea salt | 2 | Bottom | square | No |
| 3 | sea salt | 5 | Top | square | No |
| 4 | sea salt | 5 | Top | rectangle | No |
| 5 | sea salt | 5 | Bottom | rectangle | No |
| 6 | sea salt | 15 | Top | rectangle | No |
| 7 | sea salt | 15 | Bottom | rectangle | No |
| 8 | crystal light | 2.5 | in roll | rectangle | No |
| 9 | sea salt | 10 | in roll | rectangle | No |
| 10 | sea salt | 25 | in roll | rectangle | No |

As illustrated in Table 8, use of a high barrier film in constructing the flavor pouch successfully eliminated the presence of grey dough in the CFL canned dough product after 41 days of refrigerated storage regardless of flavorant type, flavorant amount, pouch shape or pouch placement within the can.

TABLE 9
100 day shelf-life test with GBB canned dough product having high
barrier pouch material

| | | Pouch Size | | | Grey |
|---|---|---|---|---|---|
| | Flavorant | (grams of | Pouch | Pouch | Dough |
| Can # | Type | flavorant) | Placement | Shape | Present |
| 1 | sea salt | 2 | Top | square | No |
| 2 | sea salt | 2 | Bottom | square | No |
| 3 | sea salt | 5 | Top | square | No |
| 4 | sea salt | 5 | Top | rectangle | No |
| 5 | sea salt | 5 | Bottom | rectangle | No |
| 6 | sea salt | 15 | Top | rectangle | No |
| 7 | sea salt | 15 | Bottom | rectangle | No |
| 8 | crystal light | 2.5 | in roll | rectangle | No |
| 9 | sea salt | 10 | in roll | rectangle | No |
| 10 | sea salt | 25 | in roll | rectangle | No |

As illustrated in Table 9, use of a high barrier film in constructing the flavor pouch successfully eliminated the presence of grey dough in the CFL canned dough product after 100 days of refrigerated storage regardless of flavorant type, flavorant amount, pouch shape or pouch placement within the can.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

1. A canned dough product comprising:
a can body having a first end cap and a second end cap;
an ingredient pouch constructed of a high barrier material, the ingredient pouch enclosing a flavorant; and
a dough product,
wherein the ingredient pouch and the dough product are enclosed within the can body such that the ingredient pouch and dough product are in direct contact.

2. The canned dough product of claim 1, wherein the ingredient pouch comprises a rectangular-shaped ingredient pouch or a square-shaped ingredient pouch.

3. The canned dough product of claim 2, wherein the dough product comprises a dough product and the rectangular-shaped ingredient pouch is rolled within adjacent layers of the dough product.

4. The canned dough product of claim 2, wherein the dough product comprises a dough product and the rectangular-shaped ingredient pouch is positioned between the can body and an exterior surface of the dough product.

5. The canned dough product of claim 1, wherein the ingredient pouch comprise a circular disc-shaped ingredient pouch.

6. The canned dough product of claim 5, wherein the dough product comprises a stacked arrangement of dough units and the circular disc-shaped ingredient pouch is positioned between adjacent dough units.

7. The canned dough product of claim 5, wherein the disc-shaped ingredient pouch is positioned with a first pouch surface in contact with the first end cap and a second pouch surface in contact with the dough product.

8. The canned dough product of claim 7, wherein the first pouch surface and second pouch surface define a pouch area wherein the pouch area is less than a cap area defined by the first end cap.

9. A method for packaging a canned dough product comprising:
positioning an ingredient pouch in direct contact with a dough product; and
enclosing the ingredient pouch and the dough product within a can having a can body, a first end cap and a second end cap.

10. The method of claim 9, wherein the step of positioning comprises placing a rectangular-shaped ingredient pouch on a flat sheet of dough and wherein the flat sheet of dough is rolled to form a dough product with the rectangular-shaped ingredient pouch is between adjacent layers of the dough product.

11. The method of claim 9, wherein the step of positioning comprises forming a dough product and where the ingredient pouch is a rectangular-shaped ingredient pouch and the rectangular-shaped ingredient pouch is placed adjacent an exterior surface of the dough product.

12. The method of claim 9, wherein the step of positioning comprises placing a circular disc-shaped ingredient pouch between a pair of adjacent dough units.

13. The method of claim 9, wherein the step of positioning comprises placing a circular-disc-shaped ingredient pouch with a first pouch surface in contact with the first end cap and a second pouch surface in contact with the dough product.

14. The method of claim 13, further comprising:
proofing the dough product within the enclosed can to form an internal can pressure up to about 35 psig.
